(19) United States
(12) Patent Application Publication
(10) Pub. No.: US 2013/0297427 A1
(43) Pub. Date: Nov. 7, 2013

(54) SYSTEM AND METHOD FOR PROVISIONING OF SERVICES AND PRODUCTS

(71) Applicant: John Karakatsanis, Alimos (GR)

(72) Inventor: John Karakatsanis, Alimos (GR)

(21) Appl. No.: 13/997,876

(22) PCT Filed: Dec. 2, 2011
(86) PCT No.: PCT/US11/63127

§ 371 Date: Jul. 25, 2013

Related U.S. Application Data
(60) Provisional application No. 61/427,957, filed on Dec. 29, 2010.

(51) Int. Cl. G06Q 30/02

(52) U.S. Cl. CPC G06Q 30/0272
USPC 705/14.68

(57) ABSTRACT

A method for promoting and provisioning of products and services including: creating a first business account for a first business offering first products or services; creating a second business account for a second business offering second products or services; creating a promoter account for a plurality of promoters to promote the first and second products or services; linking the first business, the second business, the first and the second products or services to the promoters. The linking enables a respective promoter to promote a selected portion of the first and second products or services and enables the first and second businesses to provision the first or second products or services, respectively; presenting the selected portion of the first and second products or services to a user; receiving a user selection of a presented product or service; and scheduling a time for rendering the selected product or service to the user.

### CROSS-REFERENCE TO RELATED APPLICATIONS

This Patent Application claims the benefits of U.S. Provisional Patent Application Ser. No. 61/427,957, filed on Dec. 29, 2010 and entitled “Cross Business Promoting And Provisioning Of Services And Products,” the entire content of which is hereby expressly incorporated by reference.

### FIELD OF THE INVENTION

The present invention relates generally to computer software and systems; and more particularly to a system and method for provisioning of services and products.

### BACKGROUND

Many companies that sell products or services are interested in expanding their product offerings and relationships with consumers. The companies want the ability to increase the number and type of products and/or services being offered to each consumer by them in order to provide the consumer with a “total solution,” without having to inventory an unmanageable number of products or services. Cross-selling products or service across a number of businesses enables a business, for example a hotel, to offer additional products or services, such as, transportation, restaurant or tour services to its customers, without having to actually provide those services. However, cross-selling products and services to customers creates certain challenges with regard to managing the quality, cost, rendition, and proceeds for such products or services.

Using the Internet, consumers are able to purchase products and services through a growing number of distribution channels. For example, consumers can shop for products and services via traditional brick and mortar branches, online stores, telephone call centers, and catalogs. Many of these distribution channels may be promoting products offered by other businesses. There is little or no integration between these various distribution or contact points and as a result, the consumer often experiences inconsistency and confusion.

Accordingly, there is a need for an automated process to promote and provision cross selling products and services and be able to be easily used by the businesses and consumer to manage and track information about the products and services.

### SUMMARY

In some embodiments, the present invention is a method executed by one or more computers for promoting and provisioning of products and services. The method includes: creating a first business account on a server computer for a first business offering a plurality of first products or services; creating a second business account on the server computer for a second business offering a plurality of second products or services; creating a promoter account on the server computer for a plurality of promoters to promote the first and second products or services offered by the first and second businesses, respectively; linking the first business, the second business, the first products or services, and the second products or services to the plurality of the promoters in a database, wherein the linking enables a respective promoter of the plurality of promoters to promote a selected portion of the first and second products or services and enables the first and second businesses to provision the first or second products or services, respectively; presenting a portion of the selected portion of the first and second products or services to a user, by a respective promoter; receiving a user selection of a presented product or service, from the user; and scheduling a time for rendering the selected product or service to the user by the first or the second business. One or more of the plurality of promoters is the first business promoting a portion of the second products or services offered by the second business in addition to the first product or services offered by the first business.

### BRIEF DESCRIPTION OF THE DRAWINGS

FIG. 1A is an exemplary flow diagram of a method, executing on one or more computers, for promoting and provisioning of products and services, according to some embodiments of the present invention.

FIG. 1B is an exemplary flow diagram illustrating cross selling the services of one business by another business, according to some embodiments of the present invention.

FIG. 2 is an exemplary block diagram depicting the interrelations of different entities and business services to promote or provide services, according to some embodiments of the present invention.

FIG. 3 is an exemplary flow diagram illustrating an account setup process, according to some embodiments of the present invention.

FIG. 4 is an exemplary flow diagram illustrating a service promoting process, according to some embodiments of the present invention.

FIG. 5 is an exemplary flow diagram illustrating a service provisioning process, according to some embodiments of the present invention.

FIG. 6 shows an exemplary user interface (UI) screen menu for services to be promoted, according to some embodiments of the present invention.

FIG. 7 shows an exemplary UI screen for available restaurant services to be promoted, according to some embodiments of the present invention.

FIG. 8 depicts an example of service-items to be promoted, according to some embodiments of the present invention.

FIG. 9 shows an example of a calendar screen to be used for selecting service date, according to some embodiments of the present invention.

FIG. 10 shows an example of a date screen to be used for selecting service time, according to some embodiments of the present invention.

FIG. 11 shows an example of a UI screen used to record the guest ID, according to some embodiments of the present invention.

FIG. 12 shows an example of a group of services and related service-items, according to some embodiments of the present invention.

FIG. 13 shows examples of data structures and the relationships between businesses, services and service-items, according to some embodiments of the present invention.

FIG. 14 shows an example of a table of service link requests between businesses and an acceptance status of the invitation requests, according to some embodiments of the present invention.

FIG. 15 shows an example of a table of service-item reservations and their status, according to some embodiments of the present invention.

FIG. 16 shows an example of a user profile table and a services-access table and their relationship, according to some embodiments of the present invention.

### DETAILED DESCRIPTION

The present invention is directed to a system and method for cross business promoting and provisioning of services and products. The method according to the invention is performed by one or more computers, for example, in a client-server type of environment, in which the computers are accessible via a communications network, such as the Internet. Some embodiments of the present invention is best suited for hotels and their staff, which via the use of a portable electronic device and online real-time web database access, in the process of serving their guest interested in locating additional services to consume, for example dinner in local restaurants that the hotel may not have and that are offered by other businesses in the area, the system and method of the invention allows the hotel to make the reservation directly to the external restaurant business. The hotel may in cooperation with other businesses in the area, for their mutual benefit, promote the external business services in concert with its own hotel services and thus may provide the guest with a comprehensive set of services to increase guest satisfaction or business revenue.

The guest may also derive additional benefits, for example discounts or quality of the external services guaranteed by the hotel, which would not have been available if the guest was to go to those business on his own. The hotel may thus provide the guest with a more comprehensive set of services, for example, by incorporating restaurant services in its services list. Other services that are usually searched for or requested by guests are transportation services such as taxi, spa treatments, restaurants, tours and outdoor activities such as, water sports, hiking, etc.

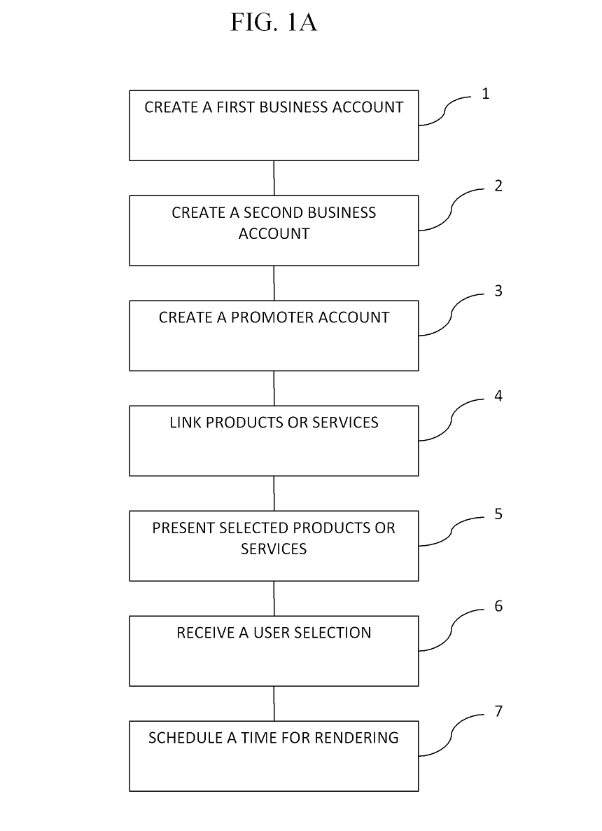

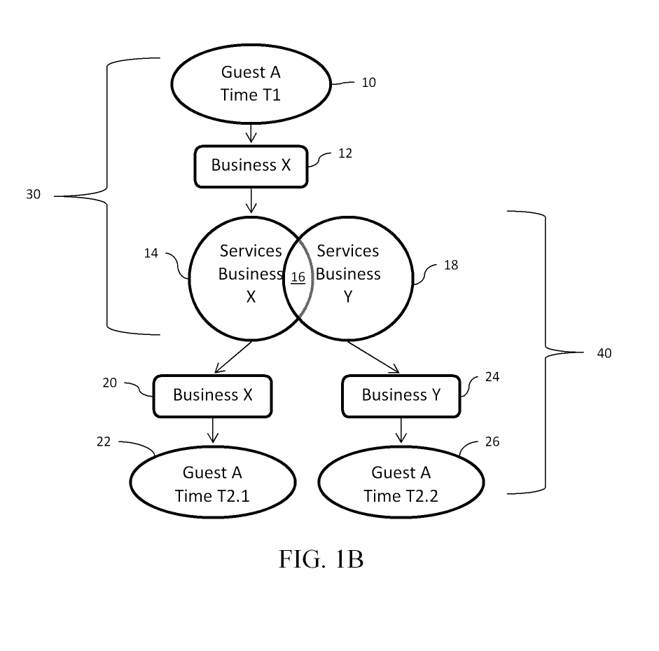

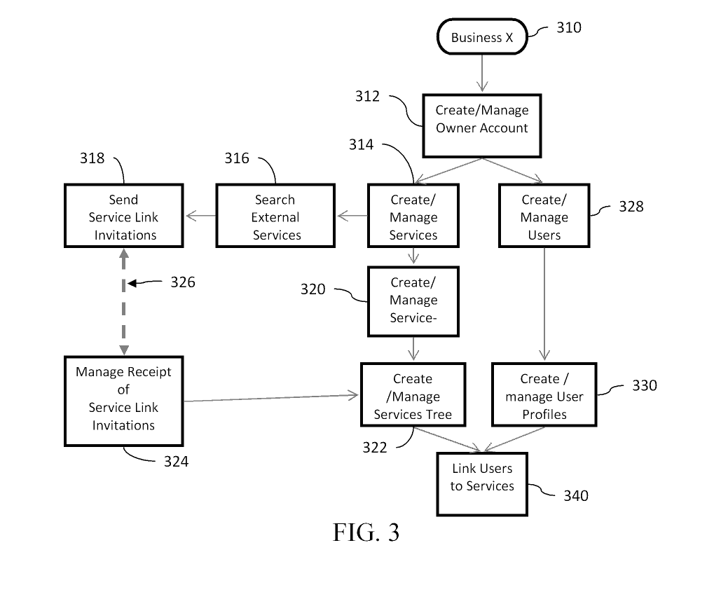

FIG. 1A is an exemplary flow diagram of a method, executing on one or more computers, for promoting and provisioning of products and services, according to some embodiments of the present invention. In block 1, a first business account is created on a server computer for a first business that is offering a plurality of (first) products or services. Similarly in block 2, a second business account is created on the server computer for a second business that is offering a plurality of (second) products or services. In block 3, a promoter account is created on the server computer for a plurality of promoters to promote the first and second products or services offered by the first and second businesses, respectively. FIG. 3 depicts a more detail process for creating the above-mentioned accounts.

In block 4, the first business, the second business, the first products or services, and the second products or services are linked to the plurality of the promoters in a database. The linking enables each (a respective) promoter to promote a selected portion of the first and second products or services. The linking also enables the first and second businesses to provision their respective products or services.

In block 5, a portion of the selected portion of the first and second products or services (to be promoted by a respective promoter) are presented to a user, by a respective promoter. The user can then select a product or service being presented and the invention then receives a user selection of a presented product or service, from the user, in block 6. In block 7, a time for rendering the selected product or service to the user (by the first or the second business) is scheduled.

The method of the present invention can also be used by various types of businesses wishing to gain synergies by having a promoter of one business (Business X) promote, reserve or even order the products or services of another business (Business Y). During the agreed upon time and place, Business Y performs the promoted services. However, there may also be occasions that Business X can provide the services offered by Business Y on behalf of Business Y.

One example of the versatility of the invention is a car sales person who can also order a subscription to an automobile magazine for which the two businesses, car dealership and magazine publisher, have previously reached an agreement to, via a common online (e.g., the Internet) database server utilizing web services or other communication technologies.

That is, the car sales person can sell the service of the magazine publisher (the Provider) to the car buyer promoted by the car sales person, the Promoter.

FIG. 1B is an exemplary flow diagram of a method, executing on one or more computers, for cross selling the services of one business by another business in addition to selling its own services. As shown, Guest A at time T1 (10), in contact with Business X

Promoter 12 who has an electronic device to promote the services or products, shows the available services or products of both his own business (Business X 14) and of those which have been linked 16 and exist on the system database, in addition to the services or products provided by Business X 14, but provided by Services Business Y 18 and its Business Y

Provider 24. Once Guest A at time T1 (10) decides on a service provided by Business Y, the Business X Promoter 12 enters in the system the reservation of a service offered by Services Business Y 18. At a later time T2.2, Guest A 26 shows up at the pre-agreed upon location to receive the services provided by Business Y (Provider 24). Similarly, Guest A 10 at time T1 can order services offered by Services Business X 14 and receive the services from Business X Provider 20. Although in this example, services are being promoted or offered by the businesses, computer executed method of the present invention treats promoting or offering products similarly.

Promoter or Service Promoter, as used in the example, is a Guest Relations person, a Receptionist, a Waiter, Reservation Agent or any individual of the business in contact with Guests. However, the Promoter can also be a sales person, agent or representative of any type of business. Additionally, the Promoter does not need to be an employee of either business, neither Business X nor Business Y, in order to be able to promote, reserve or order a service. However, the Promoter is given access to the system by the Promoting business (e.g. Business X in the preferred scenario).

Promoting, is used to indicate at least the presentation of the available services or products to a guest. However, it usually includes reserving a service or product, ordering or even providing the service or product on behalf of the other company.

Provider or Service Provider may refer to a restaurant waiter, a spa receptionist, taxi driver, water sports attendant or other roles related to serving hotel guests inside the hotel (i.e. Business X) or outside the hotel (i.e. Business Y). The Provider is the individual or individuals or system or process, automatic or manual of a business who actually provides the agreed upon services or products.

Provisioning is used herein to include the delivery of a service or product by a hotel to a Guest and the consumption of the service or product, by the guest. However, the provisioning may be of any type of service or product by any business. Selling is used in this document to include the promotion, the provisioning of a service or products, or both.

FIG. 3 is an exemplary flow diagram illustrating an account setup process executing on one or more computers, according to some embodiments of the present invention. The invention allows a business 310 to create, change or delete, in general manage, the Owner account 312 on the system (e.g., a server computer). The Owner account is automatically given Administration privileges allowing it to create, change or delete Users, Services, Service-Items, Services Tree or Links to other business services. Although in this example, services are being promoted or offered by the businesses, computer executed method of the present invention treats promoting or offering products similarly.

The Owner then creates, changes, deletes and in general manages services 314 to be provided by the Business X 310. The services include Service-Items 320 which are the service items promoted and provided to the guest (e.g., a client of the Owner of Business X).

The Owner may also search for external services 316 in the system server database for other businesses of complementary services in nearby areas which would be willing to promote Business' X services. Upon locating such businesses, the Business X 310 may send a Service Link invitation 318 which the other business may accept, ignore or reject. Businesses logically search for complementary services in a nearby area but neither of this is a requirement for the invention. The businesses use their own criteria for which other business services and which other areas they wish to link with.

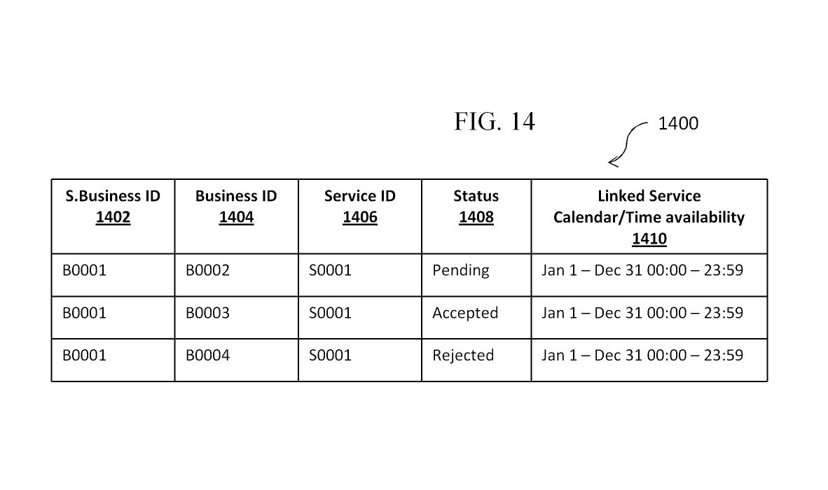

The requests of Service Links between businesses is shown by the dotted line 326 and elaborated upon below in the discussion of FIG. 14. Sending of the service-link invitation in monitored and managed by the Manage Receipt of Service Link Invitations 324 by the other business.

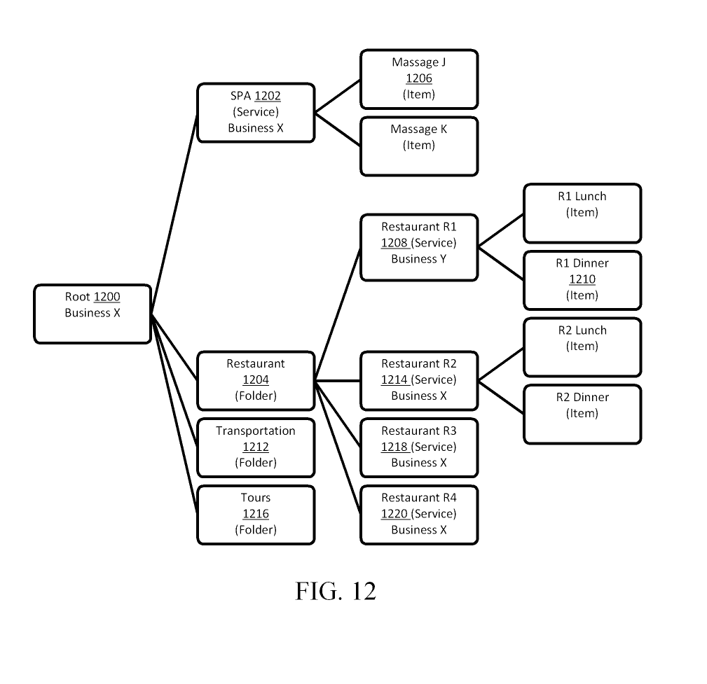

After sending the Service Link Invitations, the Business X may proceed in Managing the Service Link Invitations 324 requests sent by other businesses to Business X. The Business X has the option to accept, ignore or reject the Service Link Invitation requests that Business X has received from other businesses. Upon acceptance of the Service Link Invitation requests the Services of other businesses are available for promoting along with Business X own services. At this point the services, Business X and those linked with other businesses, may be included in the Services Tree 322. An example of Services Tree is shown in FIG. 12. In some embodiments, once a business has accepted the invitation from Business X, an automatic cross-linking is performed to cross-link the product or services (or a portion thereof) of the two businesses together for cross-selling.

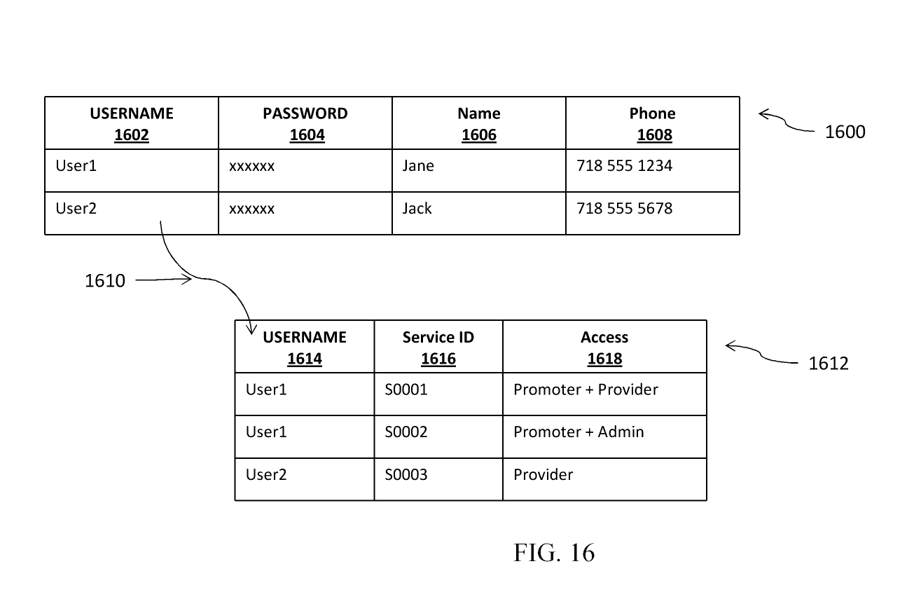

The Business X also creates and manages users (328). Each user is given a username and password and a user profile 330 with individual contact information. There should be at least one user of type Provider in order to be able to at least provide the service. The promotion of the service may be left entirely to the entity (business or individual) doing the promoting. At this point (340), the Business X is able to Link Users to Services. Each user is enabled for a set of services for which they can be a Promoter or Provider or both. An example of a database table for this purpose is shown in FIG. 16.

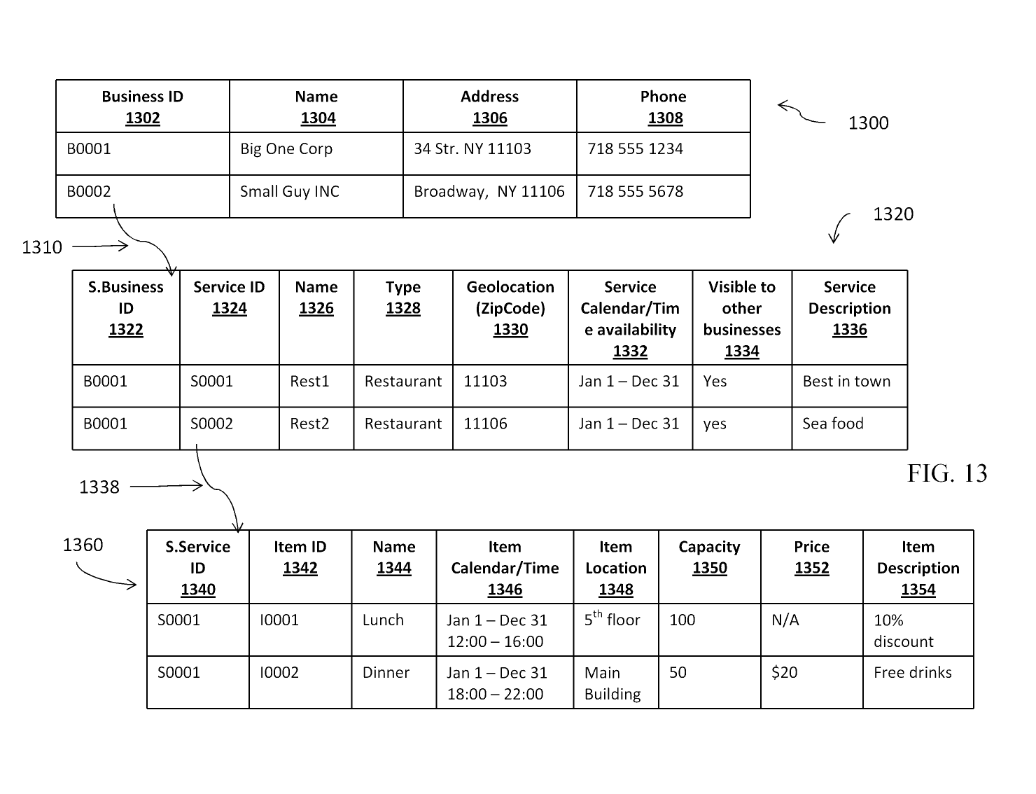

FIG. 13 shows examples of data structure and the relationships between businesses, services and service-items, according to some embodiments of the present invention. Again, one with ordinary skills in the art would readily recognize that these databases and their respective data structures are stored on one or more (local and/or remote) computers and are accessible by one or more computers via a communication network, such as the Internet. As shown, the data structure links the Business with Services and Service-Items, for example, in a relational database format. However, other software methods may also be used to create the relationships. A first database table 1300 shows an example of the data that describe the Business, including, but not limited to, the system wide unique Business ID 1302, business Name 1304, business Address 1306 and business Phone number 1308. There is a relationship 1310 between the Business ID 1302 and the S. Business (Source Business) ID 1322 of the Services table 1320.

The Services database table 1320 has in turn data that describe the services provided by the source business including system wide unique Service ID 1324, which is also used to create the reference to the Service-Item table 1360 via the relationship 1338; a service Name 1326; and a service Type 1328, which may be used to provide a search filtering for other businesses to find businesses to link to. The Services database table 1320 further includes Geo-location (Zip Code) 1330 that may also be used for locating other businesses by the geographical area to link to: Service Calendar/Time availability 1332 that is used to provide date and time availability of the service; Visible to other Businesses 1334 that is used to indicate whether or not a service should be visible to other businesses searching for services; and Service Description 1336 that gives more information to the guest on the service being promoted.

There is also a relationship 1338 between the Services table 1320 and the Service-Items table 1360 utilizing the Service ID 1324 of the Services table 1320 and the reference to S. Service (Source Service) ID 1340 of the Service-Items table 1360. The Service-Items table 1360 includes data that describe the service-items. Each service-item has a system wide unique service Item ID 1342; a service Name 1344; Item Calendar/Time 1346 to hold the service-item availability; Service Item Location 1348 that gives more detailed information to the Promoter and Guest where the service is offered; Capacity 1350 that indicates the total number of service-items available to be consumed and thus promoted; Price 1352 that is used to indicate a price when applicable; and Item Description 1354 that may be used to give more detailed information on the service-item.

The data in the Capacity 1350 may vary based on the type of service. For example, a restaurant reservation for dinner may have just a total capacity that it can serve and therefore the number may be limited. However, a spa massage depends on the availability of specific individuals. This scenario includes just one example of scheduling because the combinations of service-item availability options that may be utilized are readily found in reservation or scheduling algorithms.

FIG. 14 shows an example of a database table of service link requests between businesses and an acceptance status of the invitation requests, according to some embodiments of the present invention. As shown, the Service-Link table database 1400 is generated by Service Link Invitation requests (e.g., in FIG. 3 item 318) from other businesses. In this example, there are requests between S.Business (Source Business—Originating the invitation) ID 1402 to another Business ID 1404 for the services of Service ID 1406. Additionally, the table shows the status of the link request in the Status 1408 and the Linked Service Calendar/Time availability 1410 made available from the originating business to be promoted by the Business ID 1404 to which the invitation has been sent.

This means that a business may send out a link request for its services to be promoted by another business but can also limit the calendar availability of the services available to the promoting business. An example of where this may be useful is if a restaurant wants to make its services available to guests of a local hotel during the low peak season but doesn't want to make its services available in the high peak season. The Status 1408 is used to indicate the status of the link request. Initially, the request is Pending. Once the invited business has decided whether or not to accept the link request, it can Accept or Reject the request. Of course, the invited business does not need to take any action in which case the request stays pending. Additional statuses may be used to improve upon the information given to businesses. For example, the invitation can be withdrawn by the originating business, or archived.

FIG. 16 shows an example of data tables used to store information about the users and their respective access rights to specific business services, according to some embodiments of the present invention. The exemplary table 1600 holds information related to the user (Promoter or Provider or Administrator or any combination), such as the Username 1602, Password 1604, individual's Name 1606 and Phone number 1608. Other user information that may add to the richness of the system may also be added in this table. Table 1611 is related (by 1610) to the User-Services in table 1612 by Username 1614 and Username 1602 respectively. That in turn provides information on which services are allowed to be accessed by each user and the type of Access 1618 that each user may have including but not limited to Promoter, Provider or Administrator or any combination thereof. There is also a unique Service item ID 1616 for each service-item in the system database.

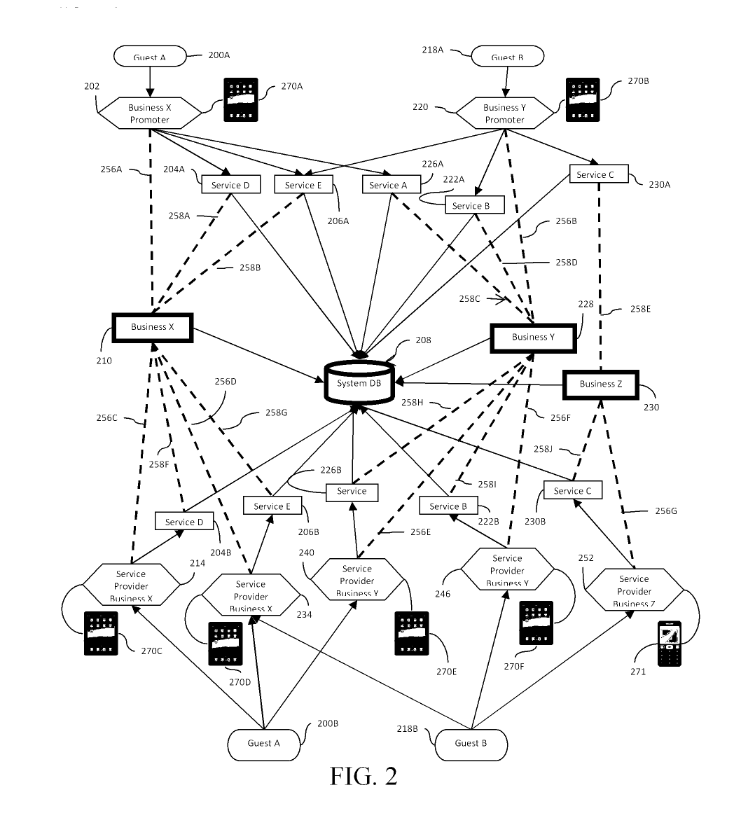

FIG. 2 shows a block diagram of a system and a method and their interrelations in utilizing business services, service-items, user and business service links to promote or provide services to guests, according to some embodiments of the present invention. Two guests are shown in this example, although the number of guests and permutation of services promoted or provided by and between businesses is practically limitless. Guest A 200A is served by Business X Promoter 202 and Guest B 218A is served by Business Y Promoter 220. Guest A 200B and Guest B 218B are provided with the promoted services, at a later time. Although in this example, services are being promoted or offered by the businesses, computer executed method of the present invention treats promoting or offering products similarly.

In this example, Business X Promoter 202 is using a portable electronic device 270A to promote Service D 204A, Service E 206A and Service A 226A to Guest A. Business X Promoter has been authorized 256A by Business X 210 to promote these services. Additionally, Business Y Promoter 220 is using a portable electronic device 270B to promote Service E 206A, Service B 222A and Service C 230A. Business Y Promoter has been authorized 256B to promote these services by Business Y 228. As each service and service-items are selected by the guests, there is a transaction of the reservation created in the system (server) database 208.

Service D and Service E were created by Business X, as shown by links 258A and 258B, respectively. Service A and Service B were created by Business Y, as shown by links 258C and 258D, respectively. Service C was created by Business Z 230, as shown by link 258E. From this example, one can see that a service, such as Service A, which was created and provided by Business Y is promoted by an individual Business X Promoter 202 of Business X.

In this example, one can also see the links between the user, Promoter or Provider, which have been created by the businesses. For instance, Business X created Business X Promoter 202 (e.g., an account), as shown in link 256A. Similarly, Business Y 228 created user Business Y Promoter 220 (e.g., an account), as shown in link 256B. It is also shown that Business Z is not promoting any services, even its own services, and thus has not created a Promoter.

On the service consumption (Provisioning) side, assuming the guests have made reservations in each service displayed, Guest A 200B (same individual as Guest A 200A, but at a later time) shows up to receive Service D 204B, which was promoted as Service D 204A to the Guest A 200A by Business X Promoter 202A. Service D 204B is provided by Service Provider Business X 214 who can see the services ordered on the portable electronic device 270C and due to be provided to the Guest A 200B. The Provider additionally records the provisioning of the service in the database 208.

Similarly, Guest A 200B may also show up to receive Service E 206B which was promoted as Service E 206A to the Guest A by Business X Promoter 202. Service E 206B is provided by Service Provider Business X 234. Finally Guest A 200B also shows up to receive Service A 226B which was promoted as Service A 226A to the Guest A by Business X Promoter 202. However, in this case, Service A 226B is provided by Service Provider Business Y 240, a business different from which the reservation was made from, because as shown in link 256E, the service was created and is therefore provided by Business Y 228.

Similarly, Guest B 218B may now consume Service E 206B which was promoted as Service E 206A to Guest B 218A by Business Y Promoter 220. Service E 206B is provided by Service Provider Business X 234. Given the assumption that all services shown in this example have been reserved by links between the guests and the services, one can see that Guest B 218B also receives Service B 222B which was promoted as Service B 222A by Business Y Promoter 220. Service B 222B is provided by Service Provider Business Y 246. Finally, Guest B also receives Service C 230B which was promoted as Service C 230A by Business Y Promoter 220. Service C 230B is provided by Service Provider Business Z 252 who is using an electronic device 271 (e.g., a smart phone) to view the pending service provisions. This shows one more example of the cross selling of business services.

Here, the service Promoter and Provider are using an electronic device 270A-270F or 271 to view and/or record a reservation during the Promotion stage or the Provisioning of a service during the service delivery stage. The Service Provider Business Z 252 (possibly using a more limited electronic device) is able to at least view the services pending for the guest. For example, a taxi driver using a smart phone 271, or other electronic devices, can see the pickup that he has to make from the hotel. The same information may also be visible to an intermediary, such as a taxi fleet manager, acting as a Service Provider Business Z 252 and through the use of a standard or cellular telephone call or by other communication means notify the taxi driver of the next pickup. Links 256A-256G show which Business created which user (Provider or Promoter). Similarly, links 258A-258J show which Business created which Service.

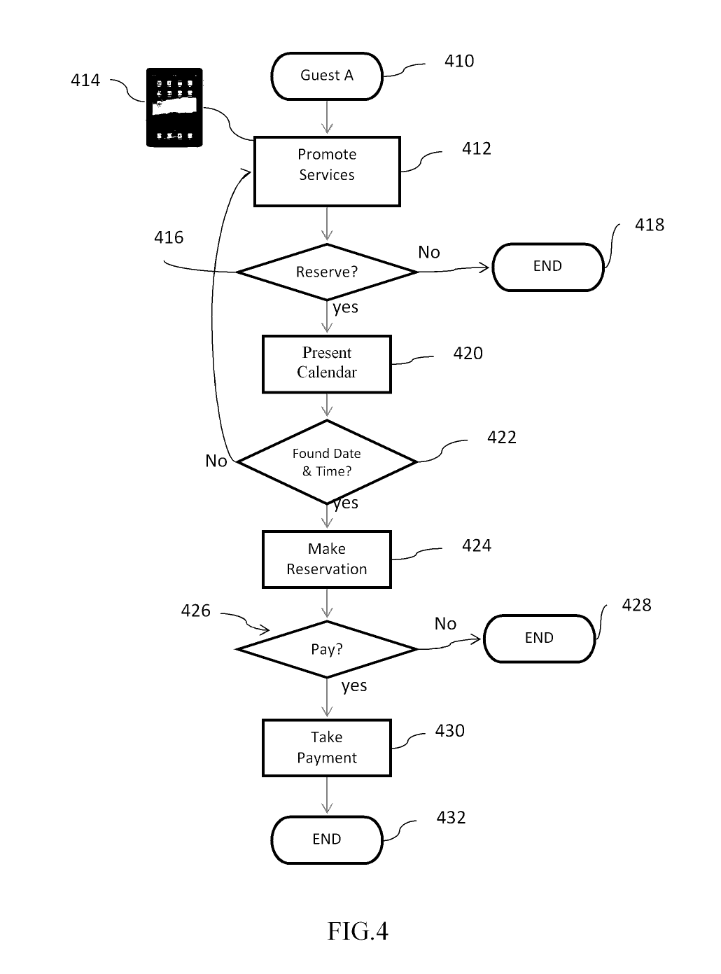

FIG. 4 shows an exemplary flow diagram for promoting services to a Guest A 410, according to some embodiments of the present invention. The Promoter promotes the Services (412) offered by a business to which the Promoter has been given authorization to promote. The Promoter displays a list of group of services (folders), services and service items utilizing an electronic device (414), from which the guest may make a selection. If the guest decides not to make a reservation (416), the process ends at 418. If the guest wishes to reserve (416), the Promoter presents the service Calendar 420. If an available date and time is found, the reservation is made 424. Otherwise, the Promoter may guide the Guest to other available services by returning to Promote Services 412. The available services, including those of other businesses to be promoted, are retrieved from the database. Although in this example, services are being promoted or offered by the businesses, computer executed method of the present invention treats promoting or offering products similarly.

If the Guest wishes to pay at that time, or if a deposit of full payment is required (426), the Promoter takes the Payment from the Guest (430) and the Promotion process ends at 432. Otherwise, if no payment is to be made, the process ends at 428.

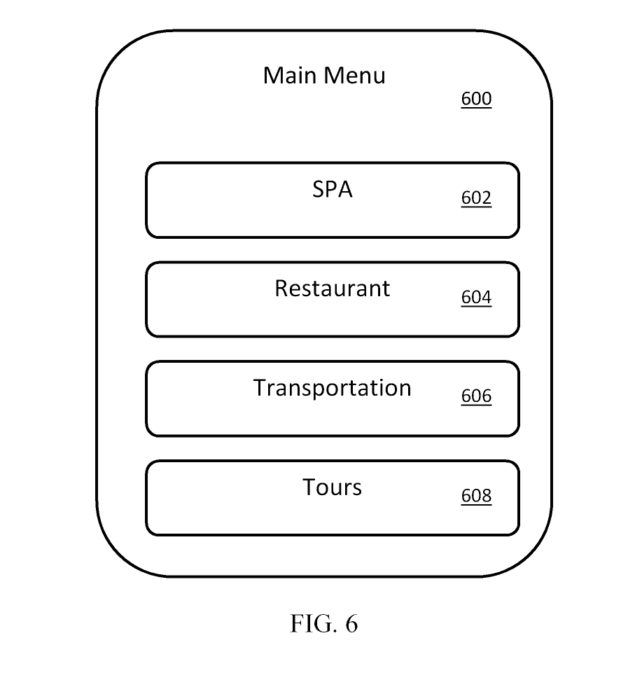

FIG. 6 shows an exemplary screen menu for services or products to be promoted to a guest, according to some embodiments of the present invention. The structure of the group of services (folders), services and service-items vary based on each business. In this example, the Main Menu 600 shows the service of a spa 602, a group of services (folder) for Restaurant 604, a group of services (folder) for Transportation 606, and a group of services (folder) for Tours 608. There are many other hotel services that hotels and related businesses offer to their guests that are not mentioned here, however, they are well within the scope of the present invention. Additionally, the invention is flexible enough to accommodate various types of businesses and thus the menu items can vary greatly between various businesses.

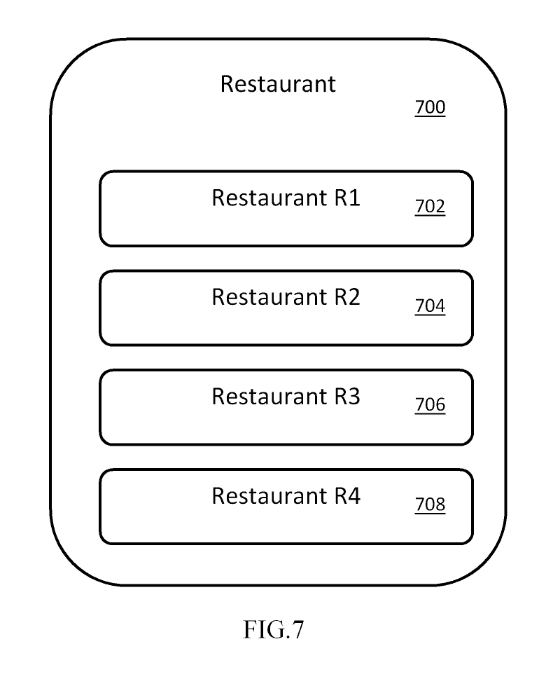

FIG. 7 shows an exemplary user interface (UI) screen for available restaurant services to be promoted, according to some embodiments of the present invention. For example, the services of the group of services Restaurant 700 that the guest may have selected from the previous screen (e.g., FIG. 6) are depicted. Each of the restaurant services is listed separately. In this example, there are Restaurant R1 702, Restaurant R2 704, Restaurant R3 706 and Restaurant R4 708.

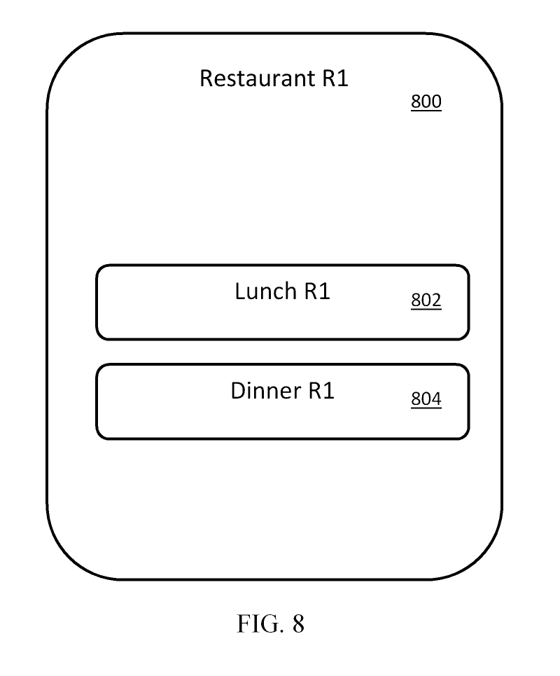

FIG. 8 shows an example of service-items to be promoted by the selected Restaurant R1, from a previous screen (e.g., FIG. 7). In this example, there are two specific Service-Items that the guest may reserve. One is Lunch R1 802 and the other is Dinner R1 804.

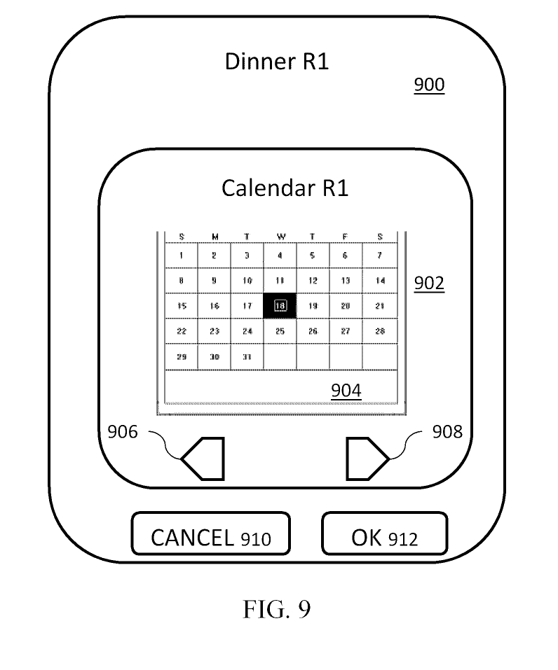

FIG. 9 shows an example of a screen Dinner R1 900 with calendar R1 902 of Dinner R1 which the Promoter guided by the Guest requirements looks for available dates to make the reservation. There are options to scroll forward 908 and backwards 906 in time in order to find an available date 904. Once selected the Promoter proceeds to the next screen to select the time using the OK button 912. Otherwise if no available date is found, the process is cancelled 910 and returned back to the main menu screen of services to be promoted, as shown in FIG. 6.

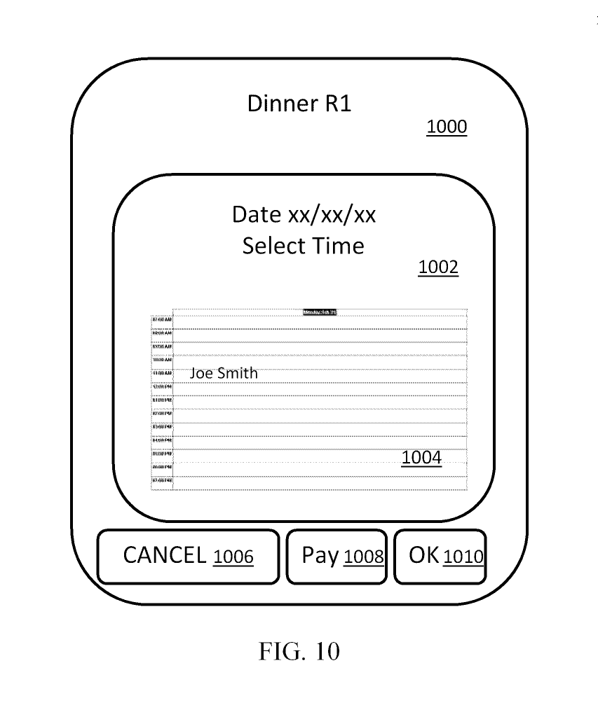

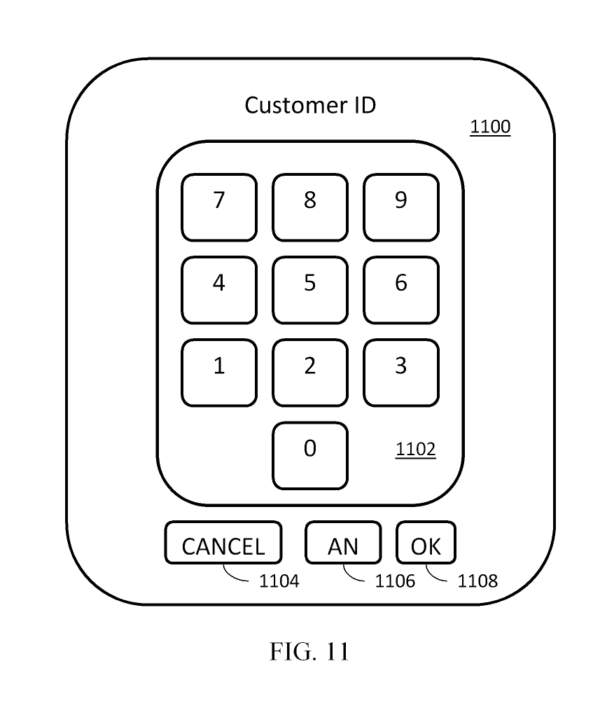

FIG. 10 shows an exemplary screen of time appointments calendar 1002, where the Promoter guided by the requirements of the guest selects an available time 1004 for the specific date selected in a previous screen, shown in FIG. 9. If the guest wishes to make a payment, deposit or full payment, or is required to make a payment, the Promoter selects the Pay 1008 button to proceed to the payment step. Otherwise, once the time is reserved, the Promoter proceeds to the next step by pressing the OK button 1010 and is taken to the next screen FIG. 11. If no available or convenient time is found, the user cancels (1006) this step and returns to the previous screen of FIG. 9 to select a different date.

FIG. 11 shows an exemplary Customer ID screen 1100 where the Promoter can enter the numeric Customer ID using a numeric keypad 1102 in order to identify the Guest to the Provider. The Promoter may also switch to an alphanumeric keypad by pressing the AN button 1106. Once the Customer ID, or name, is entered, the Promoter presses the OK button 1108 to complete the reservation process.

FIG. 12 is an example of a navigation tree traversed by the Promoter in presenting the available services and service-items to a guest, according to some embodiments of the present invention. The Promoter navigates the tree usually starting from the Root 1200 and proceeds via its branches to the group of Services (folders) to Services and finally Service-Items to be reserved. Each branch may be a folder as in the example of Restaurant 1204, or a service as in the example of spa 1202. The spa services contains service-items, for example, Massage J 1206. Folders usually contain other folders (group of services) or services such as Restaurant R2 1214. A Service usually contains at least one Service-Item. The Transportation folder 1212 and Tours folder 1216 are currently empty in this example as are services Restaurant R3 1218 and Restaurant R4 1220.

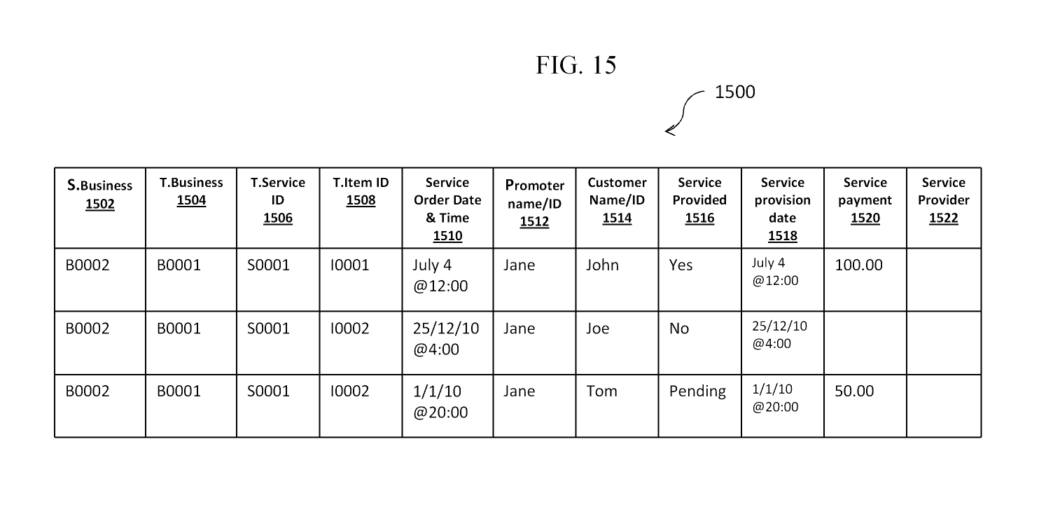

FIG. 15 shows examples of service reservation transactions recorded in a database table 1500, according to some embodiments of the present invention. Column S-Business (Source Business) 1502 identifies the business in which the Promoter has logged in as a user and made the reservation for the guest. T-Business (Target Business) 1504 identifies the business which is obligated to provide the service. T-Service (Target Service) ID 1506 identifies the service to be offered and T-Item (Target Item) ID 1508 identifies the specific service-item to be provided to the guest. The Service Order Date & Time 1510 identifies the date and time that the reservation has been made for. Promoter name/ID 1512 identifies the unique Promoter Name/ID who has made the reservation. Customer name/ID 1514 identifies the guest to be provided the services to. Service provided 1516 allows the business delivering the service to record the status of the provisioning of the requested service. Service Provision date 1518 identifies the date and time that the service was actually provided, which may be different from the original request. Service Payment Amount 1520 identifies the amount of the payment that has been made. Service Provider 1522 identifies the service provider who actually provided the service.

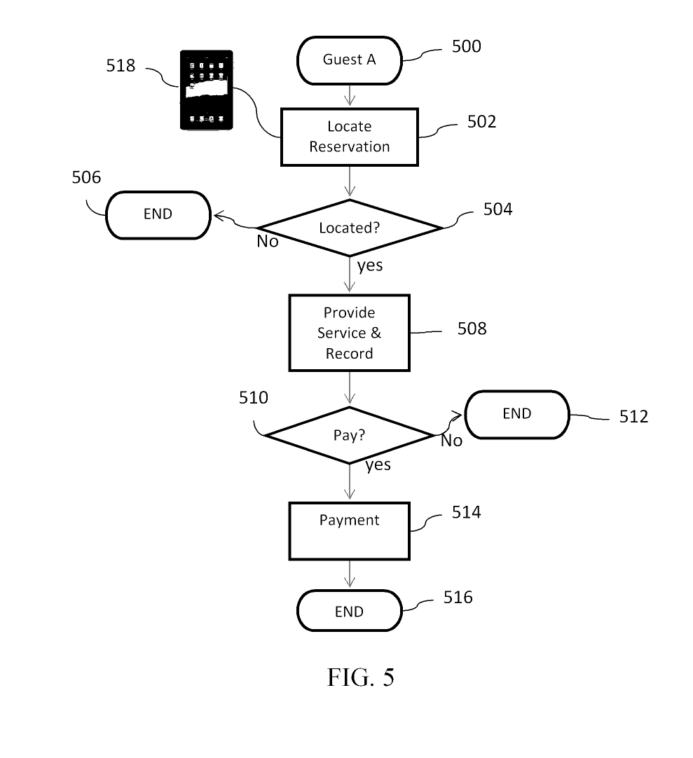

FIG. 5 is an exemplary flow diagram illustrating a service provisioning process executing on one or more computers, according to some embodiments of the present invention. The flow diagram shows an exemplary provisioning method as would normally be followed to access the system and locate the services to be offered to the guest. In this process, Guest A (500) who has ordered a service shows up at the specified location in order to consume it. The Provider locates the reserved service 502 using an electronic device 518, which accesses the system database. The Provider may locate the reservation by using the screen shown in FIG. 10 and looking at the date of the service, usually the current date; or by entering the guest ID, using screen shown in FIG. 11. Although in this example, services are being promoted or offered by the businesses, computer executed method of the present invention treats promoting or offering products similarly.

Additionally, the Provider may locate the service from the Services Tree (FIG. 12) by drilling down similarly to the Promoter using screens shown in FIG. 6-8. Once the service is located, it is provided to and recorded for the guest (508). If the service is not located, usually because there was no reservation made, the process ends at 506 and the Provider may act as a Promoter, if he has been setup as such. In this case, the Provider/Promoter accesses the system, using the Promoting process depicted in FIG. 4. After provisioning of the service to the guest, if the guest has not prepaid, the guest pays (514) and the process ends at 516. If there has been a prepayment or the service is complementary, the process ends at 512. Provisioning of Business Services in the present invention means that the business that is promoting a service is not necessarily the one that provides that service.

However, it is not prohibited that a business that is not offering the service to actually provide it and even bill for it. As an example, a hotel that has reserved a taxi service of another business, as usually is the case, may provide the taxi service, maybe utilizing one of its shuttles in the case where the taxi driver has not showed up and thus bill for the service as well as taking care of the guest's needs. In this case, the Promoter would be doing a reverse look up of the services which have been promoted to the guest to locate the service, since he would not usually be setup to also be the Provider for the other business. The ability to pay at each end of the service (i.e., the Promoting or Provisioning) means that a guest can pay for the service consumed at another business in the hotel. As an example, a guest consuming water sports of Business Y may pay the hotel Business X during the checkout process.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention as defined by the appended claims.

What is claimed is:

1. A method executed by one or more computers for promoting and provisioning of products and services, the method comprising:
creating a first business account on a server computer for a first business offering a plurality of first products or services;
creating a second business account on the server computer for a second business offering a plurality of second products or services;
creating a promoter account on the server computer for a plurality of promoters to promote the first and second products or services offered by the first and second businesses, respectively;
linking the first business, the second business, the first products or services, and the second products or services to the plurality of the promoters in a database, wherein the linking enables a respective promoter of the plurality of promoters to promote a selected portion of the first and second products or services and enables the first and second businesses to provision the first or second products or services, respectively;
presenting a portion of the selected portion of the first and second products or services to a user, by a respective promoter;
receiving a user selection of a presented product or service, from the user; and
scheduling a time for rendering the selected product or service to the user by the first or the second business, wherein one of the plurality of promoters is the first business promoting a portion of the second products or services offered by the second business in addition to the first product or services offered by the first business.

2. The method of claim 1, further comprising collecting a payment for the selected product or service from the user at the time of receiving the user selection.

3. The method of claim 1, further comprising collecting a payment for the selected product or service from the user at the time of rendering the selected product or service to the user.

4. The method of claim 1, further comprising viewing by the first or second business, a pending product or service scheduled to be rendered by the first or second business.

5. The method of claim 1, further comprising recording information about a resulting transaction at the time of rendering the selected product or service to the user.

6. The method of claim 1, further comprising sending an invitation to a third business offering a plurality of third products or services to link the plurality of third products or services to the first business, the second business, the first products or services, the second products or services, and the plurality of the promoters in the database; receiving an acceptance from the third business, and enabling respective promoters of the plurality of promoters to promote a selected portion of the third products or services.

7. The method of claim 6, further comprising automatically enabling the third business to promote a selected portion of products or services of said respective promoters.

8. The method of claim 1, further comprising presenting a calendar to the user for scheduling a time for rendering the selected product or service to the user.

9. The method of claim 1, wherein the presented products or services include one or more of the group consisting of spa services, restaurants, transportation services, and travel services.

10. The method of claim 1, wherein the first business is a hotel and the second business is one or more of the group consisting of a spa, a restaurant, a transportation service provider, and a tour operator.
